(19) United States
(12) Patent Application Publication
(10) Pub. No.: US 2014/0260290 A1
(43) Pub. Date: Sep. 18, 2014

(54) POWER-GENERATING APPARATUS AND METHOD

(71) Applicant: ROLLS-ROYCE CORPORATION, INDIANAPOLIS, IN (US)

(72) Inventor: Carl NORDSTROM, Avon, IN (US)

(73) Assignee: ROLLS-ROYCE CORPORATION, Indianapolis, IN (US)

(21) Appl. No.: 14/143,356

(22) Filed: Dec. 30, 2013

Related U.S. Application Data
(60) Provisional application No. 61/778,343, filed on Mar. 12, 2013.

(51) Int. Cl. F02C 3/04

(52) U.S. Cl. CPC F02C 3/04
USPC 60/772; 60/784

(57) ABSTRACT

A power-generating apparatus includes a compressor section and a combustor section positioned downstream of the compressor section. The combustor section defines a combustion chamber operable to receive compressed fluid from the compressor section. The apparatus includes a turbine section positioned downstream of the combustor section operable to receive combustion gases from the combustion chamber and convert the combustion gases into kinetic energy. The apparatus also includes a waste container positioned downstream of the turbine section and exposed to the discharged exhaust gases. The waste container can hold waste material that receives the hot exhaust gas and combusts, further heating the exhaust gases. The apparatus also includes a conduit having an inlet fluidly communicating with the turbine section and receiving the exhaust gases. The apparatus also includes a heat exchanger operably disposed between the compressor section and the combustor section to heat the compressed fluid.

### CROSS-REFERENCE TO RELATED APPLICATIONS

This application claims priority to U.S. Provisional Application Ser. No. 61/778,343, entitled “Power-Generating Apparatus and Method,” filed Mar. 12, 2013, which is incorporated herein by reference in its entirety.

### TECHNICAL FIELD

The invention relates to an industrial engine applied to generate power, and in particular an industrial gas turbine engine for use in waste incineration applications.

### BACKGROUND

Present approaches to power generating systems in the waste incinerator field suffer from a variety of drawbacks, limitations, disadvantages and problems including those respecting energy efficiency, environmental compatibility, and waste disposal among others. There is a need for the unique and inventive lubrication apparatuses, systems and methods disclosed herein.

### SUMMARY

In summary, the invention is a power-generating apparatus. The power-generating apparatus includes a compressor section operable to compress fluid. The power-generating apparatus also includes a combustor section positioned downstream of the compressor section along the axis. The combustor section defines a combustion chamber operable to receive compressed fluid from the compressor section. The power-generating apparatus also includes a turbine section positioned downstream of the combustor section along the axis. The turbine section is operable to receive combustion gases from the combustion chamber and convert the combustion gases into kinetic energy to drive a compressor and/or an electric generator, the combustion gases are then discharged as exhaust gases. The power-generating apparatus also includes a waste container positioned downstream of the turbine section and exposed to the exhaust gases. The waste container can hold waste material and receive hot exhaust gases to combust the waste material, further heating the exhaust gases. The power-generating apparatus also includes a conduit having an inlet fluidly communicating with the turbine section and receiving the exhaust gases. The power-generating apparatus also includes a heat exchanger operably disposed between the compressor section and the combustor section to heat the compressed fluid prior to the compressed fluid being received in the combustion chamber. The heat exchanger has an inlet communicating with an outlet of the conduit. A method applied by the exemplary apparatus is also disclosed herein.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a schematic of a power-generating apparatus incorporating a first exemplary embodiment of the invention; and

FIG. 2 is a schematic of a power-generating apparatus incorporating a second exemplary embodiment of the invention.

### DETAILED DESCRIPTION

A plurality of different embodiments of the present disclosure is shown in the Figures of the application. Similar features are shown in the various embodiments of the present disclosure. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, uses waste material (garbage) that would otherwise consume space in a landfill to produce useful power. The mass and volume of the waste material can be reduced by 80% or more. Acceptable waste disposal is a significant problem facing many municipalities in the world today. Embodiments of the present disclosure can capitalize on the fact that methane released by decomposing waste material is 20 times more active as a greenhouse gas than CO₂. Burning the waste material prevents the formation of the methane, and converts the chemical energy present in the waste material into useful energy. The by-products from the embodiments of the present disclosure can be used as building materials, fertilizer, fill, acid neutralizers, icy road treatment, soap and other products. Excess heat arising from practicing embodiments of the present disclosure can be used to improve plant efficiency through steam generation and/or electric power generation.

FIG. 1 is a schematic representation of a power-generating apparatus 10, in a first embodiment of the present disclosure. The exemplary power-generating apparatus 10 can include an inlet 12 to receive fluid such as air. The power-generating apparatus 10 can include a fan (not shown) to direct fluid into the inlet 12 in alternative embodiments of the present disclosure. The power-generating apparatus 10 can also include a compressor section 14 to receive the fluid from the inlet 12 and compress the fluid. The compressor section 14 can be adjacent to the inlet 12 along a centerline axis 16 of the power-generating apparatus 10. The power-generating apparatus 10 can also include a combustor section 18 to receive the compressed fluid from the compressor section 14. The compressed fluid can be mixed with fuel from a fuel system 20 and ignited in a combustion chamber 22 defined by the combustor section 18. The power-generating apparatus 10 can also include a turbine section 24 to receive the combustion gases from the combustor section 18. The energy associated with the combustion gases can be converted into kinetic energy (motion) in the turbine section 24 to rotatingly drive one or more compressors, electric power generators, waste moving devices and the like.

In FIG. 1, shafts 26, 28 are shown disposed for rotation about the centerline axis 16 of the power-generating apparatus 10. Alternative embodiments of the present disclosure can include any number of shafts. The shafts 26, 28 can be journaled together for relative rotation. The shaft 26 can be a low pressure shaft supporting compressor blades 30 of a low pressure portion of the compressor section 14. The compressor blades, such as blade 30, can be fixed for rotation with the shaft 26. The compressor section 14 can define a multi-stage compressor, as shown schematically in FIG. 1. A “stage” of the compressor section 14 can be defined as a pair of axially adjacent blades and vanes. For example, vanes 32 and the blades 30 can define a first stage of the compressor section 14. The vanes 32 can be positioned to direct fluid downstream, to the blades 30. The vanes 34 and the blades 36 can define a second stage of the compressor section 14. The present disclosure can be practiced with a compressor having any number of stages.

The shaft 26 can also support low pressure turbine blades 38 of a low pressure portion of the turbine section 24 for rotation about the axis 16. A plurality of turbine vanes 40 can be positioned to direct fluid downstream, to the blades 38. The blades 38 convert energy associated with the combustion gases into kinetic energy (motion); the combustion gases drive the blades 38 into rotation, which drives the blades 30 and 36 into rotation.

The shaft 28 encircles the shaft 26. As set forth above, the shafts 26, 28 can be journaled together, wherein bearings are disposed between the shafts 26, 28 to permit relative rotation. The shaft 28 can be a high pressure shaft supporting compressor blades 42, 44 of a high pressure portion of the compressor section 14. A plurality of vanes 46, 48 can be positioned to respectively direct fluid downstream to the blades 42, 44. The shaft 28 can also support high pressure turbine blades 50 of a high pressure portion of the turbine section 24. A plurality of vanes 52 can be positioned to direct combustion gases over the blades 50. The blades 50 convert energy associated with the combustion gases can be converted into kinetic energy (motion); the combustion gases drive the blades 50 into rotation, which drives the blades 42 and 44 into rotation.

The combustion gases pass from the turbine section 24 as exhaust gases. Embodiments of the present disclosure can include one or more free power turbines, such as referenced at 54, to extract more energy from the exhaust gases. The free power turbine 54 can be engaged with an electric power generator 76 through a gearbox to generate electrical power.

The power-generating apparatus 10 also includes a waste container 56 positioned downstream of the turbine section 24 and exposed to the exhaust gases, referenced by arrows 58. In the first exemplary embodiment of the present disclosure, the waste container 56 can be a box-like structure as shown in the drawings or alternatively, any other suitable shape such as round or tubular. The waste container 56 can be exposed to the exhaust gases downstream of the turbine section 24. The power-generating apparatus 10 also includes a conduit 60 having an inlet 62 fluidly communicating with the turbine section 24 and receiving the exhaust gases after passing through the waste container 56. The power-generating apparatus 10 also includes a heat exchanger 64 operably disposed between the compressor section 14 and the combustor section 18 to heat the compressed fluid prior to the compressed fluid being received in the combustion chamber 22. The heat exchanger 64 has an inlet 66 communicating with an outlet 68 of the conduit 60. The heat exchanger 64 can contain two flow circuits, one relatively “cold” from the compressor section 14 and one relatively “hot” from the conduit 60. The two gas streams do not mix and are separated by the heat exchanger walls. The heat exchanger 64 can be of many different configurations including “tube in shell” or parallel plate as would be known to those skilled in the art. The heat exchanger 64 can be made of a nickel alloy or any other material in view of the particular operating environment in which an embodiment of the present disclosure will be practiced.

In a first embodiment of the present disclosure, shown schematically in FIG. 1, waste material 72 can be positioned in the interior 70 of the waste container 56 and directly exposed to the exhaust gases. Thus, the waste container 56 is disposed in fluid connection between the turbine section 24 and the conduit 60 such that the exhaust gases pass through the interior 70 of the waste container 56. In this environment, the waste material 72 can be converted into heat and ash through combustion by direct contact with the exhaust gases in the waste container 56, which contains sufficient excess air to sustain the combustion. Thus, upon leaving the waste container 56, the exhaust gas includes the heat and gases generated by combustion within the combustion chamber 22 of the combustor section 16 as well as the additional heat and gases generated by combustion of the waste material 72 in the waste container 56.

Thus, the combustion of waste material is applied to improve the cycle efficiency of the turbine engine portion of the power-generating apparatus 10. It has been estimated that in one embodiment of the present disclosure that thermal efficiency can be increased from 55% to 85% or more. After startup and initial combustion, the temperature of the exhaust gases entering the heat exchanger 64 will gradually increase, increasing the temperature of the compressed fluid entering the combustion chamber 22. Temperature increase from burning the waste material 72 translates into less energy needed from the conventional fuel, which results in improved fuel consumption and thus improved thermal efficiency of the power generating apparatus 10.

The first exemplary embodiment of the present disclosure can also include a particle remover 74 positioned between the waste container 56 and the heat exchanger 64. The particle remover 74 is operable to remove waste solids from the stream of exhaust gases passing to the heat exchanger 64. Waste solids are particles of material remaining after pyrolization and combustion. These waste solids can be removed by way of a device such as a particle separator, a high speed rotating screen, or other devices similar in operation to aircraft engine air-oil separators.

In the first exemplary embodiment of the present disclosure, substantially all of the exhaust gases passing out of the waste container 56 are directed to the heat exchanger 64. In other words, the waste container 56 and the conduit 60 can be arranged such that these components are operable to direct substantially all of the gases passing out of the waste container 56 to the heat exchanger 64. There may some small amount of gas exiting the waste container 56 when solid waste is removed, but the remaining exhaust gases can all be directed to the heat exchanger 64.

A waste moving device 78 such as a conveyer can be operable to direct waste material 72 through a waste inlet 80 of the waste container 56. The waste material 72 can be introduced to the waste container 56 via a device such as a screw pump or some other device that can maintain the pressure inside the waste container 56 at an optimum level and not allow exhaust gases to escape. The waste moving device 78 can be operated independently from the power-generating apparatus 10, or alternatively draw power from the power-generating apparatus 10.

Another embodiment of the present disclosure can include a power component operably connected to the turbine section 24 to draw rotational power. For example, in the first exemplary embodiment of the present disclosure, a generator 76 can draw rotational power from the LP shaft 26 to generate electricity. In other embodiments of the present disclosure, rotational power can rotatingly drive a gear of a gear box or the waste moving device 78, etc.

The heat exchanger 64 can also include a nozzle 82 positioned at an outlet 84 of the heat exchanger 64. The nozzle 82 can be operable to increase back pressure and accelerate exhaust gas flow through the heat exchanger 64. This can improve combustion efficiency by achieving a higher than ambient pressure for the combustion process. The nozzle 82 can be adjustable such that the back pressure generated is variable. In FIG. 1, the nozzle 82 is schematically shown in solid line and in phantom line to represent adjustability.

In some embodiments of the present disclosure, the exhaust gas 58 exiting the heat exchanger 64 can still contain significant energy and can be used in a steam cycle, further improving system overall efficiency. FIG. 1 shows the exhaust gases 58 being directed to a heat exchanger 86 that can transfer heat from the exhaust gases 58 to water for a steam turbine (not shown). Thus, an embodiment of the present disclosure can assist in the generation of power through a plurality of different mechanisms.

In another embodiment of the present disclosure, as depicted in FIG. 2, exhaust gas does not directly contact the waste material 72 at least initially, and therefore will not burn the waste material 72 through a combustion process, but instead cause thermochemical decomposition through pyrolysis. Pyrolysis is the transformation of a substance that is produced by the action of heat in the absence of excess oxygen necessary to sustain combustion. Pyrolysis is the chemical decomposition of condensed substances by heating and can occur spontaneously at high enough temperatures. Pyrolysis is a process which involves heating biomass to drive off the volatile matter, leaving behind, for example, the black residue similar to charcoal. Pyrolysis can also be applied to collect volatiles such as gaseous compounds or oils. Thus, waste material 72 directed into a portion of the waste container 56 that is shielded from direct contact with the exhaust gases can undergo pyrolization. The waste material can break down into different forms of volatile/combustible material, such as solid and fluid. Once pyrolyzed, the volatile portion of the waste material can be used directly as a gaseous and/or liquid fuel for powering an apparatus or simply stored for later use. The solid portions of the pyrolyzed byproducts of waste material can be reintroduced into the waste container 56 such that combustible matter can be combusted to add heat to the exhaust gasses prior to the exhaust gasses entering the heat exchanger 64.

A power-generating apparatus 10a illustrated in FIG. 2 includes similar components and systems as the power-generating apparatus 10 illustrated in FIG. 1 and can operate substantially similar in some configurations. Thus, the power-generating apparatus 10a and will not be described in the same detail as the power-generating apparatus 10 above. The power-generating apparatus 10a includes a compressor section 14, a combustor section 18, and a turbine section 24 positioned along a centerline axis 16. The power-generating apparatus 10a also includes a waste container 56 positioned downstream of the turbine section 24 and exposed to the exhaust gases, referenced by arrows 58. In this exemplary embodiment of the present disclosure, the waste container 56 can include a waste conduit 57 positioned therein. The waste conduit 57 can be tube-like in one form, but can take on any shape or configuration to operate in the defined environment. A waste moving device 78a can be used to transport waste 72 from a source to the waste conduit 57 in the waste container 56. The waste moving device 78a can be similar to the waste moving device 78 used with the power-generating apparatus 10 or alternatively have a different configuration to transport waste material 72 to the waste conduit 57. One or more additional moving devices (not shown) may also be utilized to move the waste 72 through the waste conduit 57. The exterior 88 of the waste conduit 57 can be exposed to the exhaust gases 58 downstream of the turbine section 24. Exhaust gases 58 pass across the exterior 88 of the waste conduit 57 to heat and pyrolyze the waste material 72 that is moving through the waste conduit 57.

A fuel system 20 is operable to direct fuel into a combustion chamber 22 of the combustor section 18. A duct is shown schematically with arrow 90 and can extend between the waste conduit 57 and the fuel system 20. Pyrolyzed matter derived from waste material 72 in the form of liquified or gasified products can be directed to the fuel system 20 and supplied as fuel for the combustor 22. Additional processing may be necessary in some applications to ensure that the pyrolyzed matter is compatible as a fuel in the combustion chamber 22. The additional processing may include filtering, constituent separation and/or further refining. Solid matter such as ash or charcoal like substances and the like can be separated and transported through a solid pyrolyzed waste conduit represented by arrow 92 and back into the waste container 56. The solid pyrolyzed waste can then be further decomposed through combustion of any remaining combustible material via exhaust gas passing through the waste container 56. The portion of solid waste that remains in the waste container 56 after combustion is complete can then be removed from the waste container 56 as required. The removal process of noncombustible solids can be continuous or intermittent as best defined by one skilled in the art.

The control system for embodiments of the present disclosure can be based on the temperature of the exhaust gases entering the turbine section 24 and/or based on the output power derived from a power output shaft. As the temperature of the compressed fluid entering the combustor section 18 increases due to the added heat transmitted from the heat exchanger 64, the amount of fuel supplied to the combustion chamber 22 can be reduced to control the temperature of the combustion gasses entering the turbine section 24 to a desired temperature. Power output, torque and/or rotational speed of a component can also be controlled through modulating fuel supplied to the combustion chamber 22. It is anticipated that the amount of heat released from combustion of waste material 72 can vary and that peak and valley adjustments through the use of conventional fuel and or fuel derived from pyrolyzed waste by-products can be employed to maintain a desired power.

Generally, the power-generating apparatus 10 or 10a can directly burn waste material 72 via hot exhaust gas like an incinerator. The additional heat generated from combustion of waste material 72 in the waste container 56 aft of the turbine section can increase the temperature of the exhaust gas 58 entering the heat exchanger 64 downstream of the compressor section 14. The power-generating apparatus 10a can also be operable to pyrolyze the waste material 72 because the exhaust gases do not initially come into direct contact with the waste material 72. Because there is not enough oxygen in the waste conduit 57 to promote combustion, pyrolysis as opposed to combustion will occur. The pyrolysis process can generate gas and/or liquid by-product, which can be used as a fuel to be burned in the combustion chamber 22 of the power-generating apparatuses 10, 10a, or alternatively can be in other devices or transported to storage tanks for future use. Fluid products generated from pyrolization, in liquid or a gas form, can be reintroduced into the engine either at the combustor section 18 or in the waste container 56. Solid by-products from the pyrolysis having combustible material remaining therein can be burned in a waste container 56. This will release additional heat and increase the temperature of the exhaust gas in the heat exchanger 64, improving system efficiency. In FIG. 2, a conduit 92 can define a passageway between an interior 70 of the waste conduit 57 and the waste container 56. Solid pyrolyzed matter generated in the waste conduit 57 can be delivered to and burned in the waste container 56. Practicing the teachings of the present disclosure will permit users to produce energy out of waste matter 72 which will improve the efficiency of the power generating apparatuses 10 and 10a and simultaneously reduce the amount of waste material delivered to landfills.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A power-generating apparatus comprising:
a compressor section operable to compress fluid and including at least one blade operable to rotate about an axis of rotation;
a combustor section positioned downstream of said compressor section along said axis and defining a combustion chamber operable to receive compressed fluid from said compressor section;
a turbine section positioned downstream of said combustor section along said axis and operable to receive combustion gases from said combustion chamber and convert the combustion gases into kinetic energy and also operable to discharge exhaust gases;
a waste container positioned downstream of said turbine section and exposed to said exhaust gases;
a conduit having an inlet fluidly communicating with said turbine section for receiving said exhaust gases; and
a heat exchanger operably disposed between said compressor section and said combustor section to heat the compressed fluid prior to the compressed fluid being received in said combustion chamber, said heat exchanger having an inlet communicating with an outlet of said conduit.

2. The power-generating apparatus of claim 1 wherein said waste container is disposed fluidly between said turbine section and said conduit such that the exhaust gases pass through an interior of said waste container.

3. The power-generating apparatus of claim 2 wherein said waste container and said conduit are further defined as being operable to direct substantially all of the gases passing out of said waste container to said heat exchanger.

4. The power-generating apparatus of claim 1 further comprising:
a particle remover positioned between said waste container and said heat exchanger and operable to remove waste solids from a stream of gases passing to said heat exchanger.

5. The power-generating apparatus of claim 1 wherein the waste container further comprises:
a waste conduit having an interior fluidly isolated from said turbine section wherein exhaust gases pass around an exterior of said waste conduit.

6. The power-generating apparatus of claim 5 further comprising:
a fuel system operable to direct fuel into said combustion chamber; and
a duct extending between said waste conduit and said fuel system such that fuel derived from pyrolyzed waste material is delivered to said fuel system.

7. The power-generating apparatus of claim 1 further comprising:
a conveying device operable to direct waste through a waste inlet of said waste container.

8. The power-generating apparatus of claim 1, wherein said waste container further comprises:
a waste container disposed fluidly between said turbine section and said conduit such that the exhaust gases pass through an interior of said waste container
a first conduit positioned within the waste container having an interior fluidly isolated from said exhaust gases; and
a second conduit extending from said first conduit for transporting pyrolyzed matter formed in the interior of said first conduit another location.

9. The power-generating apparatus of claim 1 further comprising:
a nozzle positioned proximate an outlet of said heat exchanger.

10. A method comprising:
compressing fluid with a compressor section of a power generation apparatus;
generating combustion gases by receiving and combusting the compressed fluid in a combustion chamber of a combustor section positioned downstream of said compressor section;
expanding the combustion gases with a turbine section positioned downstream of said combustor section;
converting the combustion gases into kinetic energy with the turbine section;
discharging exhaust gases from the turbine section into a waste container;
heating waste matter in the waste container with the exhaust gases;
increasing temperature of the exhaust gas with combustion of waste material; and
directing the exhaust gas to a heat exchanger operably disposed between the compressor section and the combustor section to heat the compressed fluid prior to the compressed fluid being received in the combustion chamber.

11. The method of claim 10 wherein said directing step is further defined as:
directing substantially all of the exhaust gases passing out of the waste container to the heat exchanger.

12. The method of claim 10 further comprising:
interconnecting the compressor section and the turbine section with at least one shaft; and
drawing rotational power from the at least one shaft with a component other than the compressor section.

13. The method of claim 10 further comprising:
adjusting an amount of fuel supplied to the combustion chamber to control to a desired temperature of the combustion gas entering the turbine section and/or control to a desired power output of the apparatus.

14. The method of claim 10 wherein said heating step is further defined as:
heating an exterior portion of a waste conduit positioned in the waste container with the exhaust gases; and
pyrolyzing waste material in the waste conduit.

15. The method of claim 14 further comprising:
directing at least a portion of pyrolyzed waste material to at least one of the combustion chamber or the waste container.

16. An apparatus comprising:
a gas turbine engine having a compressor section, a combustor section and a turbine section;
a waste container position downstream of the turbine section operable for receiving exhaust gas flow from the turbine and burning waste material; and
a heat exchanger adapted to receive exhaust gas generated in both the combustion section and the waste container, wherein the heat exchanger is positioned downstream of the compressor section to transfer heat to compressed air exiting the compressor section.

17. The apparatus of claim 16, wherein a portion of waste material is pyrolyzed when exposed to exhaust gases in the waste container.

18. The apparatus of claim 17, wherein the pyrolyzed waste material produces at least one of a solid fuel, liquid fuel and gaseous fuel as a by-product of a pyrolization process.

19. The apparatus of claim 16 further comprising:
a particle separator positioned in a fluid path between the waste container and the heat exchanger.

20. The apparatus of claim 16 further comprising:
an electric power generator operably connected to the apparatus.
